(19) United States
(12) Patent Application Publication
(10) Pub. No.: US 2008/0180248 A1
(43) Pub. Date: Jul. 31, 2008

(54) Eas Reader Detecting Eas Function From Rfid Device

(75) Inventors: Ming-Ren Lian, Boynton Beach, FL (US); Gary Mark Shafer, Charlotte, NC (US)

Correspondence Address: IP LEGAL DEPARTMENT;TYCO FIRE & SECURITY SERVICES, ONE TOWN CENTER ROAD, BOCA RATON, FL, 33486, US

(73) Assignee: Sensormatic Electronics Corporation, Boca Raton, FL (US)

(21) Appl. No.: 11/791,092

(22) PCT Filed: Nov. 18, 2005
(86) PCT No.: PCT/US05/41680

§ 371 Date: Feb. 25, 2008

Related U.S. Application Data
(60) Provisional application No. 60/629,571, filed on Nov. 18, 2004.

(51) Int. Cl. G08B 13/14

(52) U.S. Cl. 340/572.1

(57) ABSTRACT

A reader device for electronic article surveillance (EAS) is disclosed which includes an exciter; a transmitter, the transmitter operatively coupled to the exciter via a first signal gate; a transmitter antenna operatively coupled to the transmitter; a receiver antenna operatively coupled to a receiver front end; and a signal detector, the receiver front end operatively coupled to the signal detector via a second signal gate, wherein the exciter generates a burst of electromagnetic energy in a pulse or a continuous wave at an operating frequency of a radiofrequency identification (RFID) tag within a read range of the EAS reader such that the energy level of the burst generates a residual or ring-down signal from the RFID tag indicating the presence of the RFID tag without activating the RED functions of the tag. The ring-down signal is read by the EAS reader as an EAS function.

### CROSS-REFERENCE TO RELATED APPLICATIONS

This application claims the benefit of priority under 35 U.S.C. §119 of U.S. Provisional Patent Application Ser. No. 60/629,571 filed on Nov. 18, 2004 entitled “INTEGRATED 13.56 MHz EAS/RFID DEVICE”, the entire contents of which are incorporated by reference herein.

### BACKGROUND OF THE INVENTION

1. Technical Field

This invention relates to an integrated electronic article surveillance (EAS) and radiofrequency identification (RFID) system which is capable of performing dual EAS/RFID functions at the RFID designated frequency of 13.56 MHz and particularly to a device which is capable of detecting an EAS detection signal from an RFID device at the RFID designated frequency of 13.56 MHz without activating the RFID functions of the RFID device.

2. Background of Related Art

With the advent of RFID technology, many retailers are considering tagging merchandise (e.g., per item, per case, per pallet) with RFID tags. At the same time, electronic article surveillance (EAS) technology and devices have proven critical to the reduction of theft and so called “shrinkage”. It is envisioned that RFID devices can also provide many of the same advantages known to EAS technology coupled with additional advantages or capabilities such as inventory control, shelf reading, non-line of sight reading, etc. However, there are several issues pertaining to previously known combination EAS and RFID devices or tags or labels. Such issues include the following:

Cost—combined EAS/RFID tags or labels are generally more expensive for a retailer or manufacturer since two devices and two separate readers or deactivators are typically required.

Size—the size of a combined configuration is generally larger and typically any amount of physical overlapping results in degradation of performance.

Interference—interference can occur, if the devices are overlapped resulting in degrading performance of either or both EAS and RFID functions, unless specific design features are provided to reduce the interference caused by the overlapping.

Such issues relating to cost, size and performance degradation and interference caused by overlapping are addressed and overcome in commonly owned, co-pending U.S. Provisional Patent Application No. 60/628,303 filed on Nov. 15, 2004 entitled “Combo EAS/RFID Label or Tag”, the entire contents of which is incorporated by reference herein.

Nevertheless, a need still exists for a 13.56 MHz EAS reader device which can read a signal from an RFID device as an EAS article detection signal. In addition, a need still exists for an integrated 13.56 MHz EAS and RFID detection system with an EAS reader device which can read a signal from an RFID device as an EAS article detection signal.

### SUMMARY

It is an object of the present disclosure to perform an EAS function with an EAS reader coupled to an RFID label or device. It is also an object of the present disclosure to provide an integrated EAS and RFID system which can detect the presence of an RFID device with a resonant circuit based on or due to resonance of the circuit.

It is another object of the present disclosure to provide an EAS reader integrated into an RFID system so as to permit a larger detection distance or read range than that available from a conventional EAS reader and EAS label combination. The present disclosure relates also to an EAS detection system configured to have a smaller, lower cost label with greater simplicity.

The present disclosure relates to a reader device for an electronic article surveillance (EAS) system including a reader device configured to operatively communicate with a radio frequency identification (RFID) tag. The reader device is configured to generate a burst of electromagnetic energy having an energy level. The energy level is equal to an operating frequency of the RFID tag positioned within a read range of the reader device, wherein the energy level of the burst of electromagnetic energy is sufficient to generate a ring-down signal from the RFID tag following termination of the generation of the burst of electromagnetic energy, wherein the reader device detects the ring-down signal received from the RFID tag, the detection of the ring-down signal being interpreted by the reader device as an EAS function. The reader device may include an exciter; a transmitter operatively coupled to the exciter by way of a first signal gate; a transmitter antenna operatively coupled to the transmitter; a receiver antenna having a front end; and a signal detector operatively coupled to the front end of the receiver by way of a second signal gate, wherein the exciter generates the burst of electromagnetic energy. The exciter may be one of a pulsed and continuous wave exciter. The EAS reader device may generate the burst of electromagnetic energy at a baseline frequency of 13.56 MHz. The burst of electromagnetic energy induces a signal from an RFID tag within a read range of the EAS reader. The first signal gate disables the transmitter and the second signal gate enables the receiver to receive the signal from the RFID tag. The signal detector actuates an alarm operatively coupled to the signal detector upon detecting the signal from the RFID tag.

The electromagnetic energy may have a maximum field strength of 84 dbμV/m at a distance of 30 meters from the reader device and the electromagnetic energy fluctuates within a frequency range of ±7 kHz with respect to the baseline frequency. Alternatively, the electromagnetic energy may have a maximum field strength of 50.5 dbμV/m at a distance of 30 meters from the reader device and the electromagnetic energy fluctuates within a frequency range of ±150 kHz with respect to the baseline frequency. Furthermore, the electromagnetic energy may have a maximum field strength of 40.5 dbμV/m at a distance of 30 meters from the reader device and the electromagnetic energy fluctuates within a frequency range of ±450 kHz with respect to the baseline frequency. In addition, the electromagnetic energy may have a maximum field strength of 29.5 dbμV/m at a distance of 30 meters from the reader device and the electromagnetic energy fluctuates within a frequency range of greater than ±450 kHz with respect to the baseline frequency.

The present disclosure relates also to a method of detecting an electronic article surveillance (EAS) function from a radiofrequency identification (RFID) tag. The method includes the steps of providing a reader device configured to operatively communicate with a RFID tag. In addition, the reader device has a read range. The method further includes the steps of generating a burst of electromagnetic energy from the reader device having an energy level. The energy level is generated at an operating frequency of the RFID tag positioned within a read range of the reader device. The energy level is sufficient to generate a ring-down signal from the RFID tag following termination of the generation of the burst of electromagnetic energy. The method includes transmitting the burst to a region of space at least within the read range; and detecting whether a ring-down signal has been received from an RFID tag within the read range of the reader device to indicate the presence of the RFID tag within the read range. The detection of the ring-down signal is interpreted by the reader device as an EAS function.

The step of transmitting the burst to a region of space at least within the read range may include the steps of transmitting the burst through a transmit antenna by way of a transmitter operatively connected to the reader device; and turning off the transmitter of the reader device. The step of detecting whether a signal has been received from an RFID tag within the read range of the reader device may include a step of enabling a receiver coupled to a receiver antenna of the reader device.

If a signal has been received from an RFID tag within the read range of the reader device, the method may further include the step of generating an alarm. If a signal has not been received from an RFID tag within the read range of the reader device, the method may include the steps of waiting a pre-specified time period; and generating a burst of electromagnetic energy from the reader device having an energy level, the energy level generated at an operating frequency of the RFID tag positioned within a read range of the reader device. The energy level is sufficient to generate a ring-down signal from the RFID tag following termination of the generation of the burst of electromagnetic energy. The method may further include the step of generating an alarm if a signal has been received by way of the receiver from an RFID tag within the read range of the reader device; and if a signal has not been received from an RFID tag within the read range of the reader device, the method includes the steps of disabling the receiver; waiting a pre-specified time period; and repeating the step of generating a burst of electromagnetic energy from the reader device having an energy level. The energy level is generated at an operating frequency of the RFID tag positioned within a read range of the reader device. The energy level is sufficient to generate a ring-down signal from the RFID tag following termination of the generation of the burst of electromagnetic energy.

The method may include generating the burst of electromagnetic energy at a baseline frequency of about 13.56 MHz. The method may be implemented by the electromagnetic energy having a maximum field strength of 84 dbμV/m at a distance of 30 meters from the reader device and the electromagnetic energy fluctuates within a frequency range of ±7 kHz with respect to the baseline frequency. Alternatively, the method may be implemented by the electromagnetic energy having a maximum field strength of 50.5 dbμV/m at a distance of 30 meters from the reader device and the electromagnetic energy fluctuates within a frequency range of ±150 kHz with respect to the baseline frequency. Yet again, the method may be implemented by the electromagnetic energy having a maximum field strength of 40.5 dbμV/m at a distance of 30 meters from the reader device and the electromagnetic energy fluctuates within a frequency range of ±450 kHz with respect to the baseline frequency. The method may also be implemented by the electromagnetic energy having a maximum field strength of 29.5 dbμV/m at a distance of 30 meters from the reader device and the electromagnetic energy fluctuates within a frequency range of greater than ±450 kHz with respect to the baseline frequency.

### BRIEF DESCRIPTION OF THE DRAWINGS

The subject matter regarded as the embodiments is particularly pointed out and distinctly claimed in the concluding portion of the specification. The embodiments, however, both as to organization and method of operation, together with objects, features, and advantages thereof, may best be understood by reference to the following detailed description when read with the accompanying drawings in which:

FIG. 1 is a profile view of a common RFID tag or label device;

FIG. 2 is a schematic diagram of a common RFID reader coupled to an RFID device;

FIG. 3 is a schematic diagram showing an EAS reader for use with an RFID device according to the present disclosure;

FIG. 4 is a functional block diagram of the EAS reader of FIG. 3;

FIG. 5 is a diagram illustrating a method of detecting an EAS function from an RFID tag according to the present disclosure;

FIG. 6A is an idealized graphical plot of an EAS burst signal versus time generated by an EAS reader device according to the present disclosure;

FIG. 6B is an idealized graphical plot of a response signal versus time from an RFID device within a read range of the EAS reader device according to the present disclosure, as detected by the EAS reader device;

FIG. 6C is a graphical plot of the EAS reader device receiver detection enablement/disablement states versus time according to the present disclosure; and

FIG. 7 is a graphical plot showing sideband generation as a result of a pulsing 13.56 MHz transmitted field.

### DETAILED DESCRIPTION

Numerous specific details may be set forth herein to provide a thorough understanding of the embodiments of the invention. It will be understood by those skilled in the art, however, that various embodiments of the invention may be practiced without these specific details. In other instances, well-known methods, procedures, components and circuits have not been described in detail so as not to obscure the various embodiments of the invention. It can be appreciated that the specific structural and functional details disclosed herein are representative and do not necessarily limit the scope of the invention.

It is worthy to note that any reference in the specification to “one embodiment” or “an embodiment” according to the present disclosure means that a particular feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

The present disclosure is directed to an apparatus for, and a method of performing an EAS function with an RFID label. With this approach, significant cost and space savings can be achieved by using one label to accomplish dual functions. The RFID function may be used for the logistic operation, such as manufacturing process control, merchandise transport, inventory, item verification for check out, return etc. The EAS function may then be performed for antitheft purposes at the exit point.

RFID labels based on 13.56 MHz systems have a front end resonant circuit with a Q factor of about 35 to 65 to capture electromagnetic energy which induces a voltage in the resonant circuit. For the RFID functionality to work, there is a minimum field requirement so that the voltage induction equals or exceeds a threshold voltage at which the RFID functions are activated. The EAS system of the present disclosure is designed to detect only the resonance of the resonant circuit of the RFID label. The detection distance or read range of such a system may be large since the response of the resonant circuit is proportional to the input magnetic field, and there is no minimum field requirement. As a result, the same RFID tag may serve as a dual-purpose device for both EAS and RFID applications.

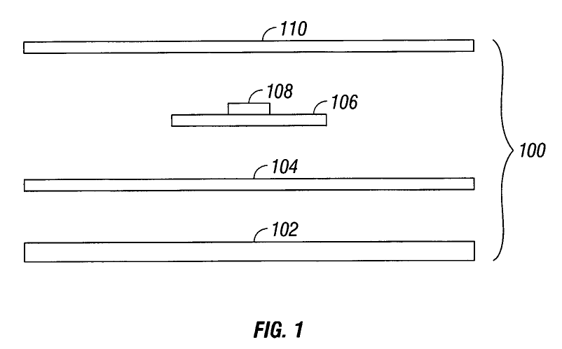

Referring now in detail to the drawings wherein like parts may be designated by like reference numerals throughout, FIG. 1 illustrates a profile view for a common 13.56 MHz RFID device or security tag or label 100. Security tag 100 typically consists of two major parts; a planar inductor element or antenna 104 mounted on a flexible substrate 102. The flexible substrate 102 may be made of plastic or paper. An RFID integrated circuit (IC) or chip 108 is attached to the planar inductor element or antenna 104, either directly or via a lead frame 106. The RFID security tag or label 100 may include a covering material 110 mounted over the IC or chip 108.

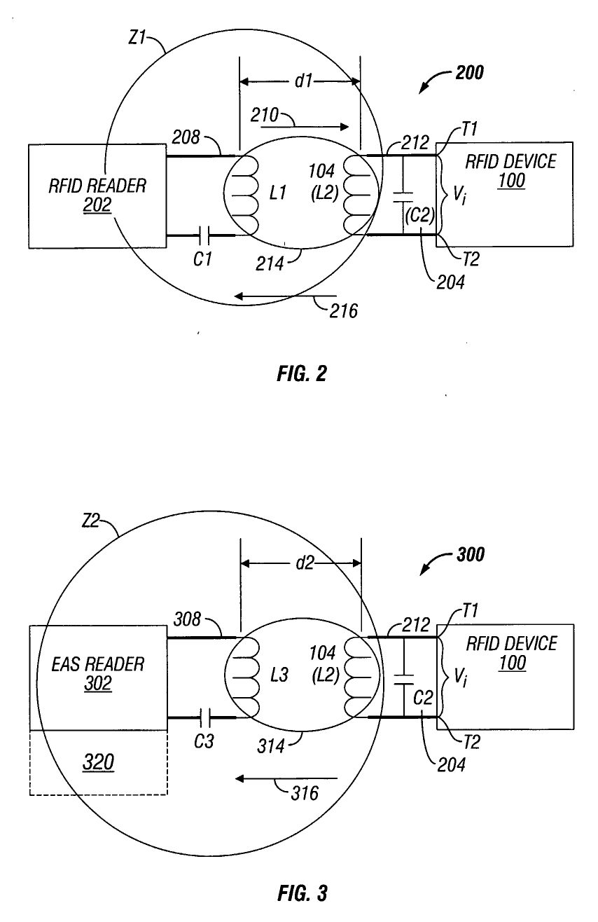

As best illustrated in FIG. 2, a common RFID security system 200 includes security tag 100. IC or chip 108 includes a built-in capacitor 204 (C2) to form a resonant circuit 212 with the planar inductor element or antenna 104 (L2). The built-in capacitor 204 (C2) is only necessary if there is insufficient capacitance in the resonant circuit 212 to tune the resonant circuit 212 to the proper frequency, and capacitor C2 may otherwise be omitted.

RFID system 200 may also include a RFID reader 202. RFID reader 202 may include a tuned circuit 208 having an inductor L1 and a capacitor C1 connected in series. The capacitor C1 is only necessary if there is insufficient capacitance in the tuned circuit 208 to adjust the frequency, and capacitor C1 may otherwise be omitted. RFID reader 202 is configured to produce a pulsed or continuous wave (CW) RF power across the tuned circuit 208 which is electro-magnetically coupled by alternating current to the resonant circuit antenna 212 of RFID security tag 100. The mutually coupled CW RF electromagnetic power from RFID security tag 100 is coupled to RFID reader 202 through magnetic field 214.

The RFID security tag 100 is a power converter circuit that converts some of the coupled CW RF electro-magnetic power 214 into direct current signal power for use by the logic circuits of the semiconductor IC 108 used to implement the RFID operations for RFID device 100. The resonant frequency of tuned circuit 208 is targeted at 13.56 MHz, with a quality factor Q ranging from about 30 to about 70 depending on the construction of the RFID security tag or label 100.

RFID device or security tag 100 may include memory to store RFID information and communicate the stored information in response to an interrogation signal 210. RFID information may include any type of information capable of being stored in a memory used by RFID device 100. Examples of RFID information include a unique tag identifier, a unique system identifier, an identifier for the monitored object, and so forth. The types and amount of RFID information are not limited in this context.

In general operation, when resonant circuit 212 of RFID device 100 is in proximity to tuned circuit 208 of RFID reader 202, an alternating current (AC) voltage Vᵢ is developed across the terminals T1 and T2 of resonant circuit 212 of RFID device 100. The AC voltage Vᵢ across resonant circuit 212 is rectified to a direct current (DC) voltage and when the magnitude of the rectified voltage reaches a threshold value V_{T}, RFID device 100 is activated. Once activated, the RFID device 100 sends stored data in its memory register by modulating interrogation signals 210 of RFID reader 102 to form response signals 216. The RFID device 100 then transmits or backscatters the response signals 216 to the RFID reader 202. RFID reader 202 receives response signals 216 and converts them into a detected serial data word bitstream of data representative of the information from RFID device 100.

The RFID system 200 as illustrated in FIG. 2 may be considered to be a high frequency (HF) RFID system because the RFID reader 202 couples inductively to the RFID device 100 via magnetic field 214.

The front end current receiving resonant circuit 212 of RFID device or security tag 100 described above, which is based on a 13.56 MHz carrier frequency, has a Q factor of about 35 to about 65 to capture electromagnetic energy. The Q factor is a measure of the voltage and current step-up in the resonant circuit at the resonant frequency and is calculated by those skilled in the art based on the particular configuration of the resonant circuit 212. The bandwidth of an antenna is calculated by taking the ratio of the resonant frequency to the Q factor.

For RFID system 200 to detect the code stored in IC 108 of passive RFID device 100, the electromagnetic radiation 214 must be transmitted at the carrier frequency at 13.56 MHz.

In addition, the transmitted waveform is also encoded in order to create a communication channel between the RFID tags/labels within a detection zone Z1. The RFID device 100 is physically separated from RFID reader 202 by a distance d1. Detection zone Z1 is defined as an imaginary surface at an effective distance Z1 generally originating from the inductor L1. The effective distance Z1 defines a read range such that if distance d1 is less than or equal to read range Z1, the RFID reader 202 induces the required threshold voltage V_{T} to activate the RFID device 100. The read range Z1 depends on, among other factors, the strength of the EM field radiation 214 from the tuned circuit 208. Therefore, the strength of the EM field radiation 214 determines the read range Z1.

For EAS applications, it is only essential to detect the presence of RFID device 100 without the need to read the code stored within, by detecting only the resonant circuit 212. As is explained in more detailed below, detecting only the resonant circuit 212 does not require a minimum induced voltage, i.e., a threshold voltage V_{T}, across the terminals T1 and T2 of the resonant circuit 212. As a result, detecting the presence of RFID device 100 for EAS applications can be more effective.

In particular, in accordance with one particularly useful embodiment of the present disclosure, FIG. 3 shows an integrated EAS and RFID system 300. Integrated EAS and RFID system 300 includes RFID device or security tag 100 and resonant circuit 212. Integrated EAS and RFID system 300 may be configured to operate using RFID device 100 having an operating frequency in the 13.56 MHz band. RFID system 100, however, may also be configured to operate using other portions of the RF spectrum as desired for a given implementation. The embodiments are not limited in this context. As shown in FIG. 3, the integrated EAS and RFID system 300 may include a plurality of nodes. The term “node” as used herein may refer to a system, element, module, component, board or device that may process a signal representing information. The signal may be, for example, an electrical signal, optical signal, acoustical signal and/or a chemical signal.

More particularly, integrated EAS and RFID system 300 differs from RFID system 100 of FIG. 2 only in that RFID reader 202 with the accompanying tuned circuit 208 comprised of inductor L1 and capacitor C1 connected in series is replaced by EAS reader 302 with an accompanying tuned circuit 308 comprised of an inductor L3 and a capacitor C3 connected in series. Again, the capacitor C3 is only necessary if there is insufficient capacitance in the tuned circuit 308 to adjust to the proper frequency, and capacitor C3 may otherwise be omitted.

As is the case of RFID reader 202, EAS reader 302 is configured to produce a pulsed or continuous wave (CW) RF power across the tuned circuit 308 which is electro-magnetically coupled by alternating current action to the resonant circuit antenna 212 of RFID security tag 100. The mutually coupled CW RF electro-magnetic power from RFID device 100 is coupled to EAS reader 302 through magnetic field or burst 314.

Although the RFID security tag 100 remains a power converter circuit that converts some of the coupled CW RF electromagnetic power or burst 314 into direct current signal power for use by the logic circuits of the semiconductor IC 108 used to implement the RFID operations for RFID device 100, unlike the case of RFID reader 202, even though the EAS reader 302 may induce a voltage Vᵢ across terminals T1 and T2 of resonant circuit 212 of RFID security tag 100 which may exceed the threshold voltage V_{T}, and the energy level of the burst 314 is sufficient to generate a ring-down signal 316 from the RFID device 100, the reader device 302 detects the ring-down signal 316 received from the RFID tag, and interprets the ring-down signal 316 as an EAS function or EAS response signal or article detection signal. Therefore, although in general operation, when resonant circuit 212 of RFID device 100 is in proximity to tuned circuit 308 of EAS reader 302 (i.e., circuit 212 and circuit 308 are separated by a distance d2, an alternating current (AC) voltage Vᵢ is developed across the resonant circuit 212 of RFID device 100 and the AC voltage Vᵢ across resonant circuit 212 is rectified to a direct current (DC) voltage), the EAS reader 302 does not activate the RFID device 100 even though threshold voltage V_{T} may be exceeded. No command codes are transmitted from the EAS reader 302 to activate the RFID device 100. As a result, since the RFID device 100 is not activated, no interrogation signals 210 are generated.

Since the RFID functions are not required to operate, very little power is required to generate only the EAS article detection signal 316 by inducing a current and a magnetic field within inductor 104 (L2) as a result of the EM field 314 originating from the EAS reader 302. The power need only be sufficient to generate the ring-down signal 316 from the RFID tag within the read range Z2 following termination of the generation of the burst of electromagnetic energy 314. Therefore, the induced voltage Vᵢ may be much less than the activation voltage V_{T} for the RFID functions.

The RFID functions are normally present in RFID device or security tag 100. In addition, the resonant circuit 212 is always present in the RFID device 100. Typically, the signal 316 is generated by the RFID device 100 regardless of the EAS status of the article, e.g., for a piece of merchandise, whether the merchandise is paid for or not paid for. Commonly owned, U.S. Provisional Patent Application No. 60/630,351, filed on Nov. 23, 2004, entitled “DISABLING DEVICES FOR AN INTEGRATED EAS/RFID DEVICE”, now concurrently-filed PCT Application Serial No. [Attorney Docket No. F-TP-00013US/WO], entitled “INTEGRATED EAS/RFID DEVICE AND DISABLING DEVICES THEREFOR” addresses the issues arising with regard to controlling generation of the signal 316 from RFID device 100 in an integrated EAS/RFID detection system, the entire contents of both of which are incorporated by reference herein.

As previously noted, the RFID device 100 is physically separated from EAS reader 302 by a distance d2. A detection zone Z2 is defined as an imaginary surface at an effective distance Z2 generally originating from the inductor L2. The effective distance Z2 defines a read range such that if distance d2 is less than or equal to read range Z2, the EAS reader 302 is capable of reading EAS article detection signal 316.

The read range Z2 depends on, among other factors, the strength of the EM field radiation 314 from the tuned circuit 308. Therefore, the strength of the EM field radiation 314 determines the read range Z2. The read range Z2 of the integrated EAS and RFID system 300 can be large since the response of the resonant circuits 212 and 308 is proportional to the input magnetic field or burst 314, and there is no minimum field requirement. As a result, the same tag can serve as a dual-purpose device for both EAS and RFID applications.

The integrated EAS and RFID system 300 as illustrated in FIG. 3 may be considered to be a high frequency (HF) integrated EAS and RFID system because the EAS reader 302 couples inductively to the RFID device 100 via magnetic field or burst 314.

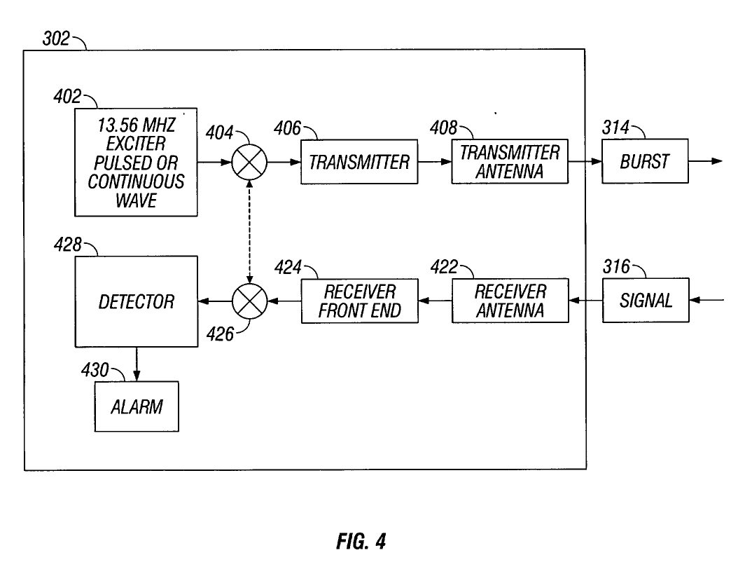

FIG. 4 illustrates a schematic diagram of one embodiment of the EAS reader 302 of the present disclosure. More particularly, the reader device 302 includes an exciter 402 which provides a pulsed or continuous wave (CW) burst transmission 314 is operatively coupled to a transmitter 406 via a first signal gate 404. The EAS reader 302 further includes a transmitter antenna 408, the transmitter 406 being operatively coupled to the transmitter antenna 408. The burst transmission 314 of electromagnetic energy may be generated at about 13.56 MHz, which is the designated frequency in the United States for RFID transmission and reception.

The reader device 302 further includes a receiver antenna 422 which receives the signal 316, and which is operatively coupled to a receiver front end 424. In turn, the receiver front end 424 is operatively coupled to a signal detector 428 via a second signal gate 426. Typically, the signal detector 428 is further operatively coupled to an alarm 430. The second signal gate 426 is disabled when first signal gate 404 is enabled. Conversely, the second signal gate 426 is enabled when first signal gate 404 is disabled.

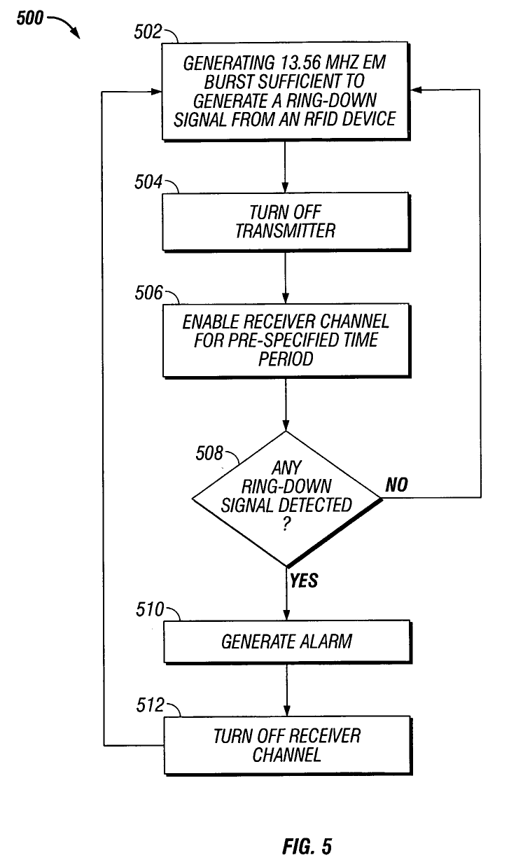

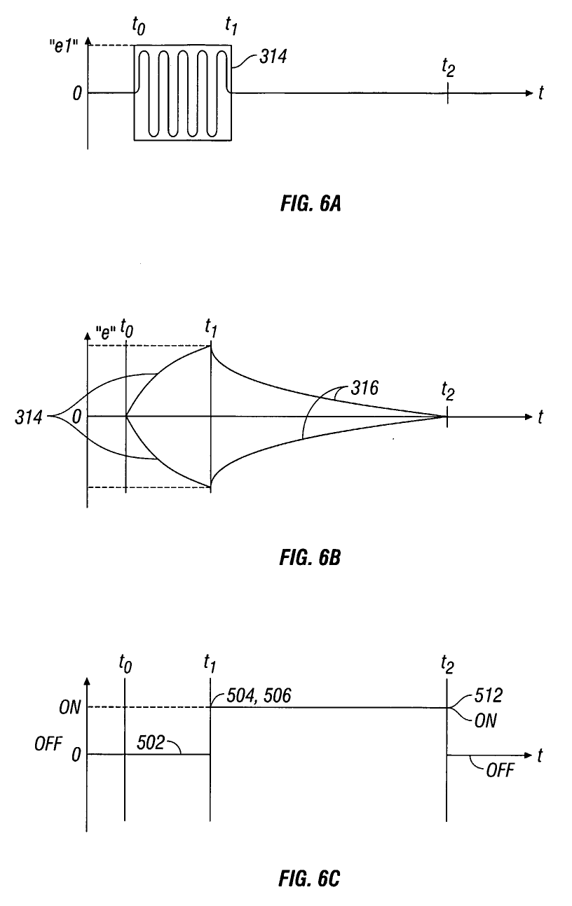

In view of FIGS. 3 and 4, FIGS. 5 and 6A through 6C disclose a method 500 of detecting an electronic article surveillance (EAS) function from the radiofrequency identification (RFID) device tag or label 100. More particularly, the method 500 includes the step 502, from time to to time t₁, of generating a burst of electromagnetic energy 314 from an EAS reader 302 at an energy level “el” sufficient to generate a ring-down signal 316 from the RFID device 100 within the read range Z2 following termination of the generation of the burst of electromagnetic energy 314. The burst 314 may be transmitted to a region of space at least within the read range Z2 and may be through transmit antenna 408 via transmitter 406 of the EAS reader 302. At time t₁, the method may include the step 504 of turning off the transmitter 406 of the EAS reader 302 and substantially simultaneously, or with a pre-specified time delay, implementing the step 506 of enabling receiver 424 coupled to receiver antenna 426 of the EAS reader 302. The method 500 further includes the step 508 of detecting via detector 428 whether the signal 316, in the form of a decaying or “ring-down” signal which indicates the presence of the RFID device 100, has been received via the receiver 424 from RFID tag 100 within the read range Z2 of the EAS reader 302. The “ring-down” signal 316 is the decaying signal which has been induced by the burst of transmission signal 314 and which is interpreted by the EAS reader 302 as an EAS response or article surveillance signal.

If a “ring-down” signal 316 has been received typically via the receiver 424 from RFID tag 100 within the read range R2 of the EAS reader 302, the method further includes the step 510 of generating an alarm. If a signal has not been received from RFID tag 100 within the read range Z2 of the EAS reader 302, the method 500 includes the step 512 of disabling the receiver 424; and after a pre-specified time period, which may be substantially simultaneously, again implementing the step 502 of generating a burst 314 of electromagnetic energy from EAS reader 302 at an energy level “el” sufficient to generate a ring-down signal 316 from the RFID device 100 within the read range Z2 following termination of the generation of the burst of electromagnetic energy 314. In one embodiment, the burst 314 of electromagnetic energy is generated at about 13.56 MHz, which, as noted previously, is the designated RFID baseline frequency for the United States.

In one embodiment, the transmit antenna 408 and the receive antenna 422 are combined into a single antenna capable of interchangeably or simultaneously transmitting and receiving the burst 314 and the EAS response signal 316.

Since the EAS reader 302 may be capable of detecting the EAS article detection signal 316 at an induced voltage Vᵢ which is less than the threshold voltage V_{T}, the read range Z2 may be greater than the read range Z1.

For the integrated EAS and RFID system 300 to detect the EAS article detection signal 316 returning from passive RFID device 100, in one embodiment the electromagnetic radiation 314 is transmitted at a carrier frequency of 13.56 MHz.

In order for the EAS function to be compatible with the RFID function, the integrated EAS reader device and RFID device 300 should function within requirements imposed by the regulatory agencies having jurisdiction. An example of such regulatory requirements is a requirement that at 13.56 MHz the radiation of energy must be contained within ±7 kHz.

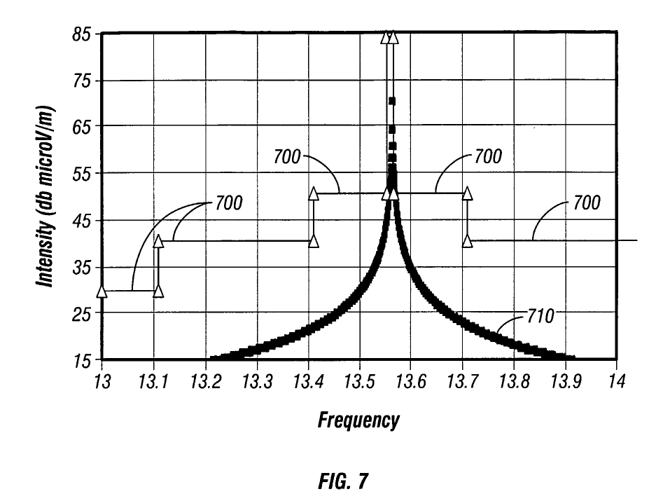

Therefore, regardless of the low induced voltage Vᵢ for the integrated EAS and RFID system 300 of the present disclosure, the radiation of energy must be contained within ±7 kHz, as shown in FIG. 7. The limits of the frequency mask are as shown in line 700 in FIG. 7. Centered at 13.56 MHz, the electric field or signal strength “e” at a distance of 30 meters from the EAS reader device 302 is not allowed to exceed an intensity of 84, 50.5, 40.5, and 29.5 decibel microvolts/meter (dbμV/m) within a frequency bandwidth range of ±7 kHz, ±150 kHz, ±450 kHz, or greater than ±450 kHz, respectively. The example regulatory requirements are also tabulated in TABLE 1 below:

TABLE 1
EXAMPLE REGULATIONS FOR 13.56 MHz ISM BAND

(dbμV/m)

| | ±7 kHz | ±150 kHz | ±450 kHz | >±450 kHz |
|---|---|---|---|---|
| Max. e-Field | 84 | 50.5 | 40.5 | 29.5 |
| at 30 m | | | | |

To fit within the spectrum of the regulatory requirement, the transmission of the electromagnetic energy burst 314 and EAS article detection signal 316 need to be close to a single tone, with a low degree of modulation, if any. For example, a continuous wave (CW) or a pulsed system with long pulse and low repetition rates will fit in such a requirement.

FIG. 7 also shows the frequency spectrum 710 of a pulsed system with a pulsed wave of about 13.56 MHz electromagnetic energy, at a pulse repetition rate of about 60 hertz, i.e., 60 pulses/second, with an actual pulse period roughly about 2.5 ms in duration. Since the available pulse duration time corresponds to the inverse of the pulse repetition rate, i.e., 1/60 sec/pulse=0.0167 sec=16.7 ms, the duty cycle for the pulsed system is then equal to the actual pulse duration time/available pulse duration time=2.5 ms/16.7 ms=about 15%. With a duty cycle of about 15%, the energy sideband generated by such a waveform 710 is below the example frequency mask 700.

By providing different reader system hardware, the passive integrated EAS/RFID marker 100 can serve as both an EAS and RFID device or perform both EAS and RFID functions.

As illustrated in FIG. 3, those skilled in the art will recognize that EAS reader 302 does not need to be a separate device and may be incorporated as part of a combined multi-function device which includes at least a combined RFID and EAS reader 320. Therefore, the reader device 320 is capable of reading both an EAS function and an RFID function of the RFID device 100.

In view of the example regulatory requirements illustrated in FIG. 7, the exciter 402 generates the electromagnetic energy “e” at a baseline frequency of 13.56 MHz. In one embodiment of the method 500, the electromagnetic energy “e” has a maximum field strength “el” of 84 dbμV/m at a distance of 30 meters from the reader device 302 and the electromagnetic energy “e” fluctuates within a frequency range of ±7 kHz with respect to the baseline frequency of 13.56 MHz. In one embodiment of the method 500, the electromagnetic energy “e” has a maximum field strength “el” of 50.5 dbμV/m at a distance of 30 meters from the reader device 302 and the electromagnetic energy “e” fluctuates within a frequency range of ±150 kHz with respect to the baseline frequency.

In one embodiment of the method 500, the electromagnetic field “e” has a maximum field strength “el” of 40.5 dbμV/m at a distance of 30 meters from the EAS reader device 302 and the electromagnetic “e” energy fluctuates within a frequency range of ±450 kHz with respect to the baseline frequency.

In one embodiment of the method 500, the electromagnetic field has a maximum field strength “el” of 29.5 dbμV/m at a distance of 30 meters from the reader device and the electromagnetic energy “e” fluctuates within a frequency range of greater than ±450 kHz with respect to the baseline frequency.

One of ordinary skill in the art will recognize that while the present disclosure is oriented towards an EAS reader device reading an EAS function from an RFID device operating at a baseline frequency of 13.56 MHz (which is the RFID frequency designated in the United States), the EAS reader device 302 may be configured to operate to read an EAS function from an RFID device operating at any other designated RFID baseline frequency. The embodiments are not limited in this context.

In summary, the present disclosure is directed to an EAS reader device or combined EAS and RFID reader which can perform an EAS function by recognizing a signal generated by an inductively coupled antenna resonant circuit included within an RFID security tag or label. With this approach, significant savings can be achieved by using one label to accomplish dual functions. The RFID functions can be used for the logistic operations, such as manufacturing process control, merchandise transport, inventory, item verification for check out, return etc. The EAS function can then be performed for antitheft purposes at exit points for the merchandise. In addition, the read range for the EAS function may be extended beyond the read range of existing EAS tags or labels.

As a result of the foregoing, a system can be built with hardware to detect the presence of the RFID device based on the resonance of the RFID components. It is contemplated that such a system would have a larger detection range. Moreover, the same RFID tag is able to perform the additional EAS function at the exit, while retaining all necessary functionality such as shelf reading, check out, inventory control, etc. More particularly, the present disclosure enables a tag or marker to be designed with the following advantages: (1) integrated EAS and RFID functions; (2) lower installation and operating costs (one combined EAS/RFID system versus two separate systems); and (3) dual function capabilities in a uniformly capable system design.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments of the invention.

What is claimed is:

1. An electronic article surveillance (EAS) reading system, comprising:
a reader device configured to operatively communicate with a radio frequency identification (RFID) tag,
said reader device configured to generate a burst of electromagnetic energy having an energy level, said energy level being equal to an operating frequency of the RFID tag positioned within a read range of the reader device, said energy level being sufficient to generate a ring-down signal from the RFID tag following termination of the generation of the burst of electromagnetic energy,
wherein said reader device detects the ring-down signal received from the RFID tag, the detection of the ring-down signal being interpreted by the reader device as an EAS function.

2. An electronic article surveillance (EAS) reading system according to claim 1, wherein the reader device includes:
an exciter;
a transmitter operatively coupled to the exciter by way of a first signal gate;
a transmitter antenna operatively coupled to the transmitter;
a receiver antenna having a front end; and
a signal detector operatively coupled to the front end of the receiver by way of a second signal gate, wherein the exciter generates the burst of electromagnetic energy.

3. An electronic article surveillance (EAS) reading system according to claim 2, wherein the exciter is one of a pulsed and continuous wave exciter.

4. An electronic article surveillance (EAS) reading system according to claim 2, wherein the first signal gate enables the transmitter to transmit the burst while the second signal gate disables the receiver.

5. An electronic article surveillance (EAS) reading system according to claim 1, wherein the EAS reader device generates the burst of electromagnetic energy at a baseline frequency of about 13.56 MHz.

6. An electronic article surveillance (EAS) reading system according to claim 2, wherein the exciter generates the burst of electromagnetic energy at a baseline frequency of about 13.56 MHz.

7. An electronic article surveillance (EAS) reading system according to claim 2, wherein the first signal gate disables the transmitter and the second signal gate enables the receiver to receive the signal from the RFID tag.

8. An electronic article surveillance (EAS) reading system according to claim 7, wherein the signal detector detects the signal from the RFID tag.

9. An electronic article surveillance (EAS) reading system according to claim 8, wherein the signal detector actuates an alarm operatively coupled to the signal detector upon detecting the signal from the RFID tag.

10. An electronic article surveillance (EAS) reading system according to claim 5, wherein the electromagnetic energy has a maximum field strength of 84 dbμV/m at a distance of 30 meters from the reader device and the electromagnetic energy fluctuates within a frequency range of ±7 kHz with respect to the baseline frequency.

11. An electronic article surveillance (EAS) reading system according to claim 5, wherein the electromagnetic energy has a maximum field strength of 50.5 dbμV/m at a distance of 30 meters from the reader device and the electromagnetic energy fluctuates within a frequency range of ±150 kHz with respect to the baseline frequency.

12. An electronic article surveillance (EAS) reading system according to claim 5, wherein the electromagnetic energy has a maximum field strength of 40.5 dbμV/m at a distance of 30 meters from the reader device and the electromagnetic energy fluctuates within a frequency range of ±450 kHz with respect to the baseline frequency.

13. An electronic article surveillance (EAS) reading system according to claim 5, wherein the electromagnetic energy has a maximum field strength of 29.5 dbμV/m at a distance of 30 meters from the reader device and the electromagnetic energy fluctuates within a frequency range of greater than ±450 kHz with respect to the baseline frequency.

14. A method of detecting an electronic article surveillance (EAS) function from a radiofrequency identification (RFID) tag, the method comprising the steps of:
providing a reader device configured to operatively communicate with a RFID tag, said reader device having a read range;
generating a burst of electromagnetic energy from the reader device having an energy level, said energy level generated at an operating frequency of the RFID tag positioned within a read range of the reader device, said energy level being sufficient to generate a ring-down signal from the RFID tag following termination of the generation of the burst of electromagnetic energy;
transmitting the burst to a region of space at least within the read range; and
detecting whether a ring-down signal has been received from an RFID tag within the read range of the reader device to indicate the presence of the RFID tag within the read range, the detection of the ring-down signal being interpreted by the reader device as an EAS function.

15. The method according to claim 14, wherein the step of transmitting the burst to a region of space at least within the read range includes the steps of:
transmitting the burst through a transmit antenna by way of a transmitter operatively connected to the reader device; and
turning off the transmitter of the reader device.

16. The method according to claim 15, wherein the step of detecting whether a signal has been received from an RFID tag within the read range of the reader device includes the step of enabling a receiver coupled to a receiver antenna of the reader device.

17. The method according to claim 15, wherein if a signal has been received from an RFID tag within the read range of the reader device, the method further comprises the step of:
generating an alarm.

18. The method according to claim 15, wherein if a signal has not been received from an RFID tag within the read range of the reader device, the method comprises the steps of:
waiting a pre-specified time period; and
generating a burst of electromagnetic energy from the reader device having an energy level, said energy level generated at an operating frequency of the RFID tag positioned within a read range of the reader device, said energy level being sufficient to generate a ring-down signal from the RFID tag following termination of the generation of the burst of electromagnetic energy.

19. The method according to claim 16, wherein, the method further comprises the step of:
generating an alarm if a ring-down signal has been received by way of the receiver from an RFID tag within the read range of the reader device; and
wherein if a ring-down signal has not been received from an RFID tag within the read range of the reader device, the method comprises the steps of:
disabling the receiver;
waiting a pre-specified time period; and
repeating the step of generating a burst of electromagnetic energy from the reader device having an energy level, said energy level generated at an operating frequency of the RFID tag positioned within a read range of the reader device, said energy level being sufficient to generate a ring-down signal from the RFID tag following termination of the generation of the burst of electromagnetic energy.

20. A method according to claim 14, wherein the burst of electromagnetic energy is generated at a baseline frequency of about 13.56 MHz.
